(19) United States
(12) Patent Application Publication
(10) Pub. No.: US 2002/0068564 A1
(43) Pub. Date: Jun. 6, 2002

(54) Systems and methods for reducing message overhead in a wireless communication network

(76) Inventors: Roger Gustavsson, San Diego, CA (US); Henrik Basilier, San Diego, CA (US); Vibhor Julka, San Diego, CA (US); Sanjeev Athalye, San Diego, CA (US)

Correspondence Address: DAVID E. BENNETT, COATS & BENNETT, P.L.L.C., 1400 CRESCENT GREEN, SUITE 300, CARY, NC, 27511, US

(21) Appl. No.: 09/884,012

(22) Filed: Jun. 18, 2001

Related U.S. Application Data
(60) Provisional application No. 60/251,247, filed on Dec. 4, 2000.

(51) Int. Cl. H04Q 7/20

(52) U.S. Cl. 455/435; 455/433

(57) ABSTRACT

A terminal for wireless communication comprises a transceiver configured to selectively tune to a carrier of a multi-service network or to a carrier of a best-effort network and a processor comprising a do not disturb function. The processor can be configured to tune the transceiver to the multi-service network and register with the multi-service network. The processor can also be configured to tune the transceiver to the best-effort carrier and register with the best-effort network. The processor can then be configured to de-register with the multi-service network when the do not disturb function is activated.

### CROSS REFERENCE TO RELATED APPLICATIONS

This application claims the benefit of priority under 35 U.S.C. §119 to U.S. Provisional Application Serial No. 60/251,247, filed Dec. 4, 2000, which is fully incorporated herein by reference.

### BACKGROUND OF THE INVENTION

1. Field of the Invention

The invention relates generally to wireless communication and more particularly to systems and methods for reducing message overhead in a wireless communication network.

2. Background

Originally, wireless communication networks primarily provided voice communication services to their users. Voice communication services are provided using circuit switched techniques. In other words, the network will open and assign a dedicated circuit or channel to each communication occurring in the network. While circuit switched service is preferred for voice communication, it is not optimal for data communication. Nonetheless, many wireless networks today offer some form of circuit switched data or packet data service. One example of such data service is Short Message Service (SMS).

For SMS, a user's terminal such as a handset is configured so that it can receive and display short text messages. A service compiles the short text message and then forwards it to the network to be sent to the user's terminal. The network opens a circuit or channel to the user's terminal and forwards the SMS message. In addition to SMS, there are other circuit switched data services such as Circuit Switched Data Service (CSDS) and High Speed Circuit Switched Data Service (HSCSDS).

More recently, wireless communication network operators have deployed packet data services. These services can be overlaid, or independent of, existing circuit switched networks. Some example packet data services are Cellular Digital Packet Data (CDPD) service, which is based on the Internet TCP/IP standard, and General Packet Radio Service (GPRS). As a result, user's handsets are now being designed to use either circuit switched or packet data services for data communication.

For example, handsets designed to support cdma2000™ can be configured to use compatible packet data services. The International Telecommunication Union (ITU) defines cdma2000™ in its IMT-2000 vision. Phase one of the cdma2000™ standard effort, known as “1xRTT” (i.e., Radio Transmission Technology), has already been completed and published by the Telecommunications Industry Association (TIA). 1xRTT refers to cdma2000™ implementation within existing spectrum allocations for cdmaOne™-1.25 MHz carriers. The technical term is derived from N=1 (i.e., use of the same 1.25 MHz carrier as in cdmaOne™) and the “1x” means one time 1.25 MHz. 1xRTT is backward compatible with cdmaOne™ networks, but offers twice the voice capacity, data rates of up to 144 Kbps, and overall quality improvements.

Also employing a 1.25 MHz channel is the High Data Rate (HDR) technology. HDR is RF compatible with cdmaOne™ and 1xRTT systems and permits side-by-side deployment of transmitters and antennas in existing CDMA towers. Unlike 1xRTT, which is optimized for circuit switched services, HDR is spectrally optimized for best effort packet data transmission. HDR delivers very high-speed wireless Internet access at peak data rates greater than 1.8 Mbps. Notably, unlike 1xRTT, the control and data channels in a HDR carrier are time multiplexed. An example of a HDR service is 1xEVDO service.

Regarding circuit switched services, during a voice communication a direct connection between the source and destination of such voice communication is established and messages travel back and forth as they are generated. As indicated above, circuit switched services may also provide data communications such as SMS messages. Regarding packet data services, packet data messages are broken up into a plurality of packets, which may travel from the source to the destination through different paths. Thus, the packets must be gathered and reassembled at the destination before the message can be delivered.

If a user's terminal is designed for both circuit switched and packet data communications, the terminal must register with the circuit switched network and the packet data network providing services to the terminal. Once registered with both networks, the terminal will “camp” on a communication channel in one of the networks. For this specification and the claims that follow, the word “camp” and its derivatives refer to the preferred tuning of the terminal to one of the networks while terminal is registered with both networks. In other words, the terminal is predominantly tuned to one of the networks with respect to time. For example, the terminal may be configured to camp on a packet data channel of the HDR network and periodically leaves the HDR network and tunes to the circuit-switched network to scan or poll a paging channel in the circuit switched network to see if there are any incoming voice or data communications. If there is an incoming communication, the terminal will switch to a channel in the circuit switched network and receive the communication.

There might, however, be situations when it is not desirable for the terminal to switch to the circuit switched network for an incoming communication. For example, the user may be engaged in a packet data communication that the user does not wish to be interrupted, or the user may just wish to not be disturbed by an incoming communication. For example, the user may be in a meeting. Further, the subscription that the user has from the wireless operator may not allowed the user's terminal to receive a voice or data communication from the circuit switched network while such terminal is engaged in a data session with the packet data network.

In present wireless communication networks there is no way for the circuit switched network to actually know whether the terminal/user wishes to receive circuit switched communications. For example, the circuit switched network has to page the terminal to notify the terminal that there is an incoming voice communication. Once the terminal receives such notification by polling the paging channels of the circuit switched network, the terminal would alert the user who would then has to decide whether to accept such incoming voice communication.

If there has been an ongoing packet data communication between the terminal and the packet data network then this above-described process will interrupt such data communication because the terminal periodically polls the paging channels of the circuit switched network. Moreover, it also results in frequent, but unnecessary, registrations with the circuit switched network and polling of paging channels on the circuit switched network. All of which introduces unnecessary signaling over the air interface of the circuit switched network. If unnecessary signalings are eliminated, the message overhead of the circuit switched network would be reduced and battery life of the user's terminal, the circuit switched network, or both the user's terminal and the circuit switched network would be prolonged.

### SUMMARY OF THE INVENTION

The systems and methods for reducing message overhead in a wireless communication network counter the problems discussed above by using terminals comprising a do not disturb function.

In one aspect, a terminal for wireless communication comprises a transceiver configured to selectively tune to a carrier of a multi-service network or to a carrier of a best-effort network and a processor comprising a do not disturb function. The processor can be configured to tune the transceiver to the multi-service network and register with the multi-service network. The processor can also be configured to tune the transceiver to the best-effort carrier and register with the best-effort network. The processor can then be configured to de-register with the multi-service network when the do not disturb function is activated.

In this manner, the do not disturb function can be activated and de-activated so as to limit the amount of pages sent from the multi-service network to the terminal and the number of registrations the terminal performs with the multi-service network. Thus, the message overhead within the network can be reduced.

Other aspects, advantages, and novel features of the invention will become apparent from the following Detailed Description of Preferred Embodiments, when considered in conjunction with the accompanying drawings.

### BRIEF DESCRIPTION OF THE DRAWINGS

Preferred embodiments of the present inventions taught herein are illustrated by way of example, and not by way of limitation, in the figures of the accompanying drawings, in which:

FIG. 1 is a diagram illustrating an exemplary wireless communication system;

FIG. 2 is a flow chart illustrating an exemplary communication flow procedure;

FIG. 3 is a logical block diagram illustrating an exemplary wireless modem that can be used to implement the procedure of FIG. 2 in a wireless communication system such as the scheme of FIG. 1;

FIG. 4 is a flow chart illustrating one example of a method for reducing message overhead in a wireless communication system in accordance with one embodiment of the invention;

FIG. 5 is another flow chart illustrating one example of a method for reducing message overhead in a wireless communication system in accordance with another embodiment of the invention; and

FIG. 6 is still another flow chart illustrating one example of a method for reducing message overhead in a wireless communication system in accordance with another embodiment of the invention.

### DETAILED DESCRIPTION OF THE PREFERRED EMBODIMENTS

The following discussion relates to wireless communication networks that include multi-service carriers configured to support voice and data communications and best-efforts carriers that are optimized for data services, such as packet data communications. For this specification and the claims that follow, packet data communications include voice over IP. It will be apparent, however, that the systems and methods described herein will apply to any system comprising a plurality of different types of networks and terminals configured to access more than one type of network. Therefore, the specific embodiments described herein are by way of example only and are not intended to limit the invention.

It should also be noted that a carrier typically comprises both a forward link from the network to the terminal and a reverse link from the terminal to the network. As used in this specification and the claims that follow, the term carrier is intended to refer to both the forward and reverse link unless otherwise specified.

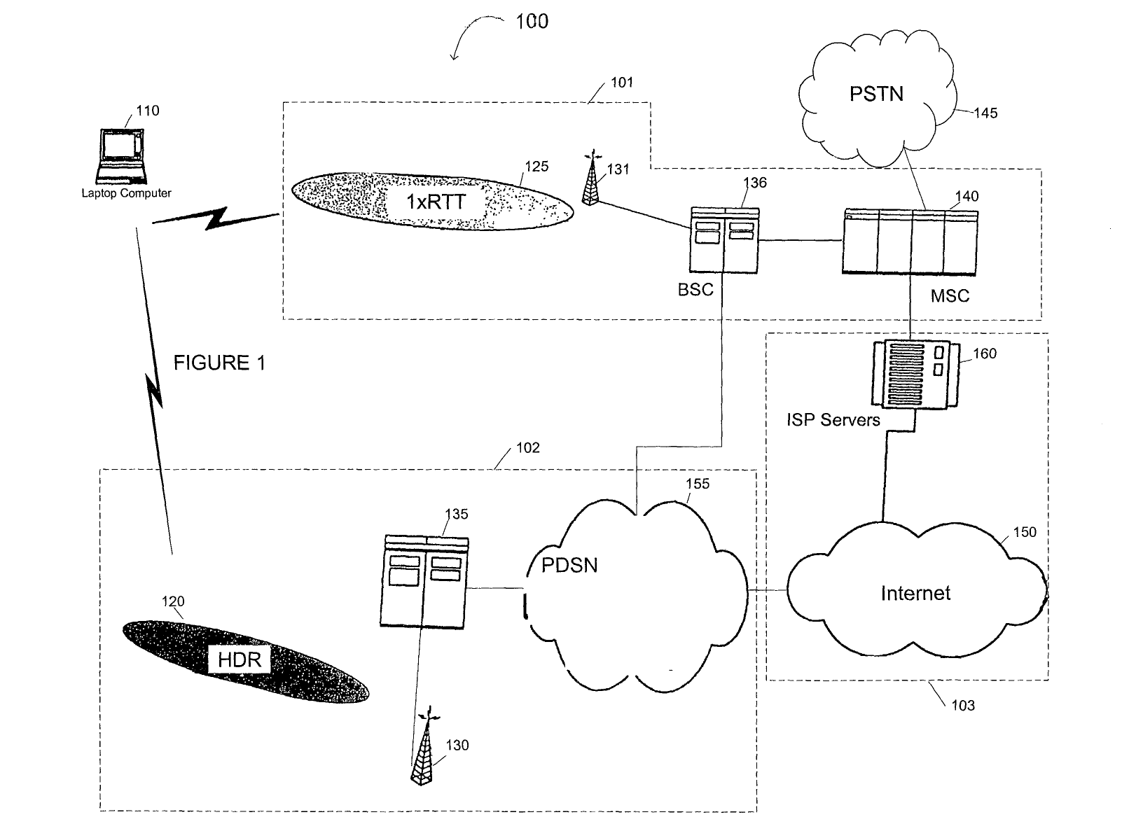

FIG. 1 illustrates a wireless communication system 100 comprising a multi-service network 101, a best-effort network 102, a public switched telephone network (PSTN) 145, and an internet network 103 that includes the Internet 150 and ISP servers 160. User at terminal 110 such as a laptop computer having a wireless transceiver (shown) or a handset (not shown) may communicate over either a best-effort carrier 120 or a multi-service carrier 125 as long as the terminal 110 is configured for dual mode operation. Multi-service carrier 125 carries multi-service communications, which may include voice, packet data, or other multi services such as SMS or broadcast information services. Best-effort carrier 120 is a carrier that is optimized for the transmission of packet data. One example of such carrier 120 is a 1xEVDO carrier. Best-effort transmitter 130 under the control of a best-effort base station controller 135 communicates with the best-effort carrier 120. Best-effort base station controller 135 is coupled to a packet data switching network (PDSN) 155. The PDSN 155 connects the Internet 150 to the best-effort base station controller 135 such that the terminal 110 can receive packet data from the Internet 150 or other sources.

Voice communications are preferably carried by a multi-service carrier 125, e.g., a 1xRTT carrier, transmitted by a multi-service transmitter 131 under the control of a multi-service base station controller 136. A mobile switching center (MSC) 140 connects the PSTN 145 with the multi-service base station controller 136. The terminal 110 may also receive packet data from the Internet 150 via the mobile switching center 140 and ISP servers 160. Alternatively, packet data can be provided directly to the base station controller 136 through the PDSN 155 or another PDSN (not shown).

The terminal 110, which is configured to use both multi-service carrier 125 and best-effort carrier 120, must register with both the MSC 140 and the PDSN 155. After registering, the terminal 110 “camps” on either the multi-service carrier 125 or the best-effort carrier 120. Assuming that the terminal is tuned to the best-effort carrier, the terminal will wait to send or receive a data communication in accordance with the protocols specific to best-effort carrier 120.

When there is an incoming communication on carrier 125, MSC 140 will cause paging notices to be sent to the terminal over the paging channels of the multi-service carrier 125. The terminal can still detect these pages by leaving the best-effort network 102 and periodically scanning or polling such paging channels. If the terminal receives a page from MSC 140, the terminal will alert the user that there is an incoming communication.

In addition, the terminal periodically leaves carrier 120 and accesses carrier 125 in order to send a registration message to MSC 140 so that the terminal can continue to receive incoming communications and pages over carrier 125.

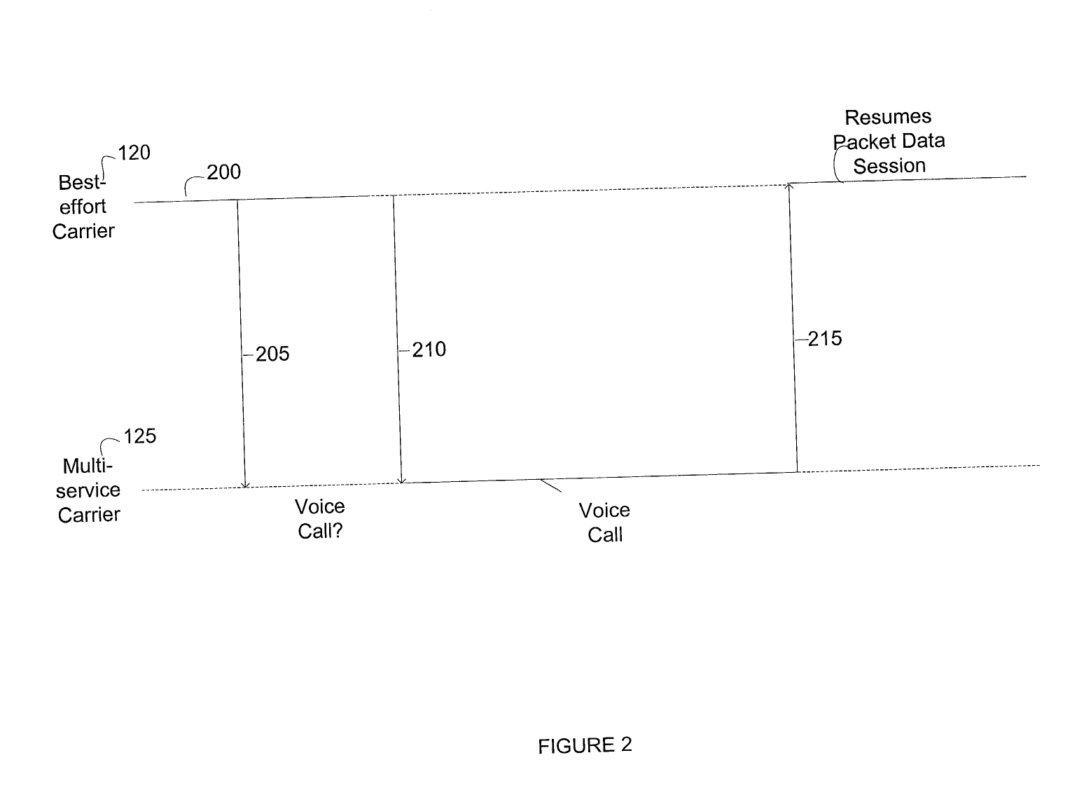

A sample communication flow procedure is illustrated in FIG. 2. Here, carrier 120 is available so that the terminal camps on and monitors the channel of such carrier. The user then initiates one or more packet data communications over carrier 120 at step 200. As demonstrated at steps 205 and 210, the terminal may periodically place the packet data communication on hold and tune to carrier 125 to look for incoming communications directed to the terminal by MSC 140. At step 205, because no such communications were detected, the terminal returns to carrier 120 and resumes the packet data communication.

At step 210, however, the terminal detects an incoming communication on carrier 125. The terminal then alerts the user of the terminal that there is an incoming communication via carrier 125 while the packet data communication is placed on hold. If the user decides to receive the incoming communication, e.g., by pressing the “talk” button, the terminal would establish an active communication over the carrier 125. Once such active communication over carrier 125 is terminated at step 215, the terminal will tune back to carrier 120 to continue with or to re-establish the packet data communication depending on whether the best-effort network 102 is still trying to communicate with the terminal or not. For example, where the incoming communication over network 101 is a voice communication, the terminal can tune to carrier 125 of the multi-service network 101 and establish a voice communication in response to the user's input. Once the voice communication is terminated, the terminal can re-tune to carrier 120. If the best-effort carrier is still trying to communicate with the terminal, the terminal would continue with the packet data communication. Otherwise, the terminal would have to re-establish any packet data communications that the terminal was previously engaged in.

If the user of the terminal decides not to receive the incoming communication, the terminal would not establish communication with the carrier 125, tune back to carrier 120, and re-establish the packet data communication.

The terminal can be a mobile station or a laptop that includes a wireless modem. The terminal can also be a Personal digital Assistant (PDA), or some other type of portable computer, that also includes a wireless modem. In fact, the terminal can be any device that includes a wireless modem configured to access a plurality of different carriers.

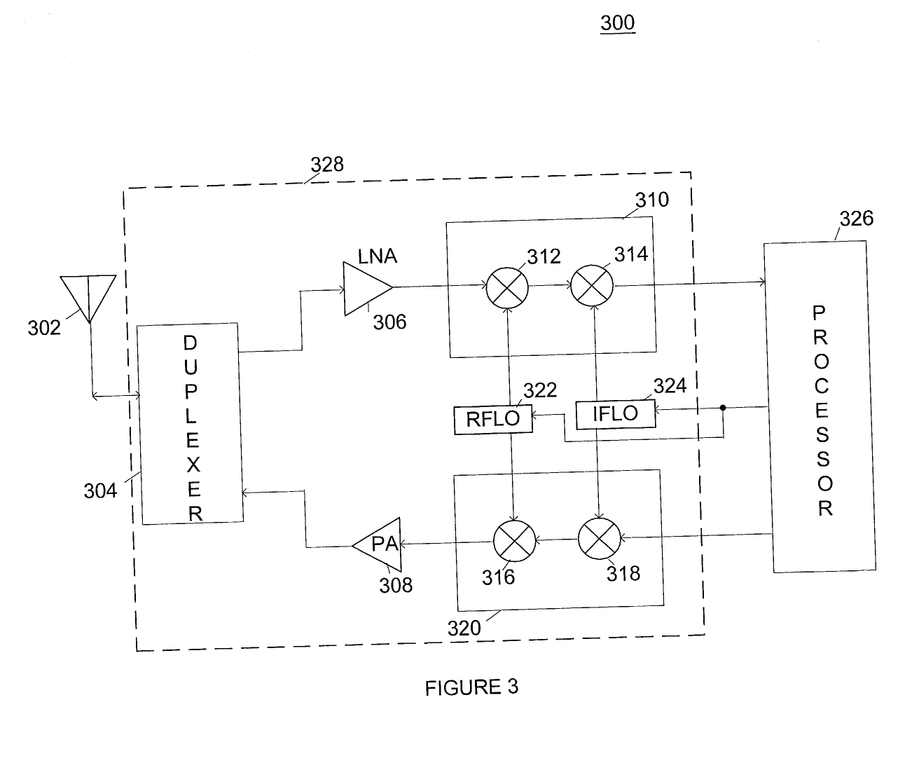

FIG. 3 illustrates an example wireless modem 300 that can be used in conjunction with the systems and methods described herein. Modem 300 includes a processor 326 and a RF section 328. RF section 328 comprises an antenna 302 for receiving Radio Frequency (RF) carrier signals. For example, antenna 302 may receive carrier 125 signals and carrier 120 signals. Antenna 302 is also configured to transmit RF signals that are encoded with data to be communicated to the respective networks. Duplexer 304 is coupled to antenna 302 and switches the antenna between receive and transmit paths within modem 300.

The receive path comprises a Low Noise Amplifier (LNA) 306 that amplifies the received RF carrier signals to a suitable level for further processing. The amplified signal is then passed to a demodulation circuit 310. In a typical receive path, demodulation circuit 310 will consist of two stages. In the first stage, a RF mixer 312 mixes the received RF signal with a RF Local Oscillator (RFLO) 322 signal and thereby generates an Intermediate Frequency (IF) signal. In the second stage, the IF signal is mixed with an IFLO 324 signal in order to step the IF signal down to a baseband signal. The baseband signal is then coupled to processor 326, which includes a processor (not shown) configured to decode any data contained in the baseband signal.

In the transmit path, data to be communicated to the network is encoded onto a baseband signal by processor 326 and coupled to modulation circuit 320. Modulation circuit 320 mixes the baseband signal up to an IF signal in mixer 318 by mixing the baseband signal with IFLO 324 signal. The IF signal is then mixed up to a RF signal in mixer 316 by mixing the IF signal with RFLO 322 signal. The RF signal is then amplified by a Power Amplifier (PA) 308 to ensure that the RF signal transmitted by antenna 302 has sufficient power.

In the transmit path, RFLO 322 must be tuned to produce the correct RF carrier signal. For example, if modem 300 is involved in a packet data communication with the best-effort network 102, then RFLO 322 must be tuned to produce a RF signal with the appropriate carrier frequency, such as a HDR carrier frequency. If, on the other hand, modem 300 is engaged in voice communication, then RFLO 322 must be tuned to produce a RF signal with the appropriate carrier frequency, such as a 1xRTT carrier frequency.

FIG. 3 illustrates that in a typical embodiment, processor 326 controls the tuning of RFLO 322. Processor 326 also tunes IFLO 324 if required; however, IFLO 324 may remain at the same frequency with only RFLO 322 being tuned. In fact, some embodiments of modem 300 may not include IFLO 324 or mixers 314 and 318. In this case, RF mixer 312 converts the received RF carrier directly to a baseband signal, and RF mixer 316 converts the baseband signal coupled from processor 326 directly to a RF signal. This type of architecture is termed direct conversion architecture.

Regardless of the specific architecture, the transmit and receive paths are typically included in one unit such as a transceiver. Therefore, in a typical embodiment, processor 326 is responsible for tuning the transceiver to the appropriate carrier, such as when the transceiver is tuned from carrier 120 to check for incoming communications over carrier 125, i.e., step 205.

There may, however, be situations in which it is not desirable for the terminal to switch to carrier 125 to receive an incoming communication. For example, the user may be engaged in a packet data communication that the user does not wish to be interrupted, or the user may just wish to not be disturbed by an incoming communication on carrier 125. For example, the user may be in a meeting where it would be inappropriate for the user to receive a communication. Further, the subscription that the user has may be such that the reception of a voice communication over the multi-service network 101 while there is an active a packet data session over the best-effort network 102 is not allowed.

In present wireless communication systems, such as system 100, there is no way for the multi-service network 101 to actually know whether the terminal or user wishes to receive any incoming communications over the multi-service network 101 while the terminal is engaged in a packet data communication with or is camped on the best-effort carrier 120 of network 102. Presently, the multi-service network 101 has to page the terminal to notify the terminal that there is an incoming voice or data communication. When the terminal receives such page by temporarily leaving the best-effort network 102 and tuning to the multi-service network 101 so as to poll the paging channels of the multi-service network 101, the terminal would alert the user that there is an incoming communication, e.g., by ringing or displaying.

If there is an ongoing packet data communication, such packet data communication is placed on hold or is interrupted because the terminal is tuned to the multi-service network 101 as described above. Moreover, it also results in frequent, but unnecessary, registrations on the circuit switched network and polling of paging channels on the circuit switched network. All of which introduces unnecessary signalings. If such unnecessary signalings are reduced or eliminated, the message overhead of the multi-service network 101 would be reduced and the battery life of the user's terminal, the multi-service network, the best-effort network or any combination thereof would be reduced.

Preferably, MSC 140 is configured so that it would stop sending paging messages to notify the terminal of certain incoming communications over the multi-service network 101 when the user does not wish to receive such communications. There are several methods of preventing MSC 140 from sending pages notifying the terminal of incoming communications over carrier 125. For example, the terminal can [1] send a de-registration message to MSC 140, [2] send a registration message to MSC 140 to inform the multi-service network 101 that terminal would like to receive only data communications, or [3] send out a signal to instruct the MSC 140 not to page the terminal regarding any voice communications and to forward all voice communications to voice mail. In the second and third embodiments, the multi-service network 101 only pages the terminal regarding data communications such as SMS messages and thus the terminal may still receive SMS messages from the multi-service network 101 via the paging channels. Generally the time associated with polling the paging channels of the multi-service network 101 by the terminal is negligible, and thus any interruption of the packet data session between the terminal and the best-effort network 102 due to polling is minimal.

In all of these cases, the multi-service network 101 would be updated or instructed so that such network 101 will not attempt to page the terminal regarding the network's receipt of an incoming voice communication. In other words, the network 101 only pages the terminal when the terminal would like to be paged regarding any incoming voice communications. Thus, the battery life of the network 101 is improved because such network 101 only pages the terminal when it is necessary to do so.

The above-described features may be implemented by providing a terminal having a “do not disturb” function therein. Such do not disturb function can be activated, for example, by using a soft key or a dedicated key on the terminal or through voice activation if the terminal includes voice recognition capabilities. In addition to manual activation, i.e., activation by a user, such feature may also be automatically activated as further described below.

Once the do not disturb function is invoked, the terminal is triggered to temporarily tune to the multi-service network 101 and request the MSC 140 [1] not to notify the terminal of any incoming voice communications or [2] to de-register the terminal with the MSC 140 so that the MSC will not notify the terminal of any incoming voice and data communications. The mobile terminal can then tune back to carrier 120 and continue to camp or continue with any packet data communications that the terminal may have been engaged in.

In the first case, the terminal may still receive SMS messages from the network 101 via the carrier 125. To do so, the terminal may periodically poll the paging channels of the multi-service network 101. Regarding incoming voice communications or calls received by the multi-service network 101, such network 101 can either forward those calls to voice mail or do not forward such calls to voice mail and/or generally indicate to caller(s) that the subscriber of the terminal is unavailable at this time. To resume the ability to receive voice pages from MSC 140, the do not disturb function must be deactivated; such deactivation may be manual or automatic. For manual deactivation, the user, e.g., may press a key on the terminal. The terminal then temporarily tunes to carrier 125 and performs a registration or sends a request to MSC 140 so as to be able to receive any voice pages again.

In the second case, the terminal is de-registered from the MSC 140 and thus the MSC will not send any voice or data pages to the terminal. More specifically, the terminal sends the de-registration message to the MSC 140 and the terminal will stop sending registration messages to, and polling for pages from, MSC 140. Thus, the terminal cannot receive any SMS messages from the network 101 via carrier 125. To resume the ability to receive pages for any incoming communications, which include voice or data communications, from the MSC 140, the do not disturb function must be disabled. The terminal then temporarily tunes to carrier 125 and performs a registration or sends a request to MSC 140 so as to be able to receive such pages again.

As indicated above, de-activation may be manual or automatic. With respect to automatic de-activation, the terminal automatically de-registers or sends a

As indicated above, de-activation may be manual or automatic. With respect to automatic de-activation, the terminal automatically de-registers or sends a request to MSC 140 to limit pages, for example, when a data communication over carrier 120 of the best-effort network 102 is about to be established. In such a case, the behavior of the terminal is controlled by the user's desire to begin packet data communication between the terminal and the best-effort network rather the user's desire to have the terminal tune to the best-effort network and only receive certain paging notices, if any, from the multi-service network. The capability to receive all voice, data or both voice and data communications over the multi-service network 101 is also re-enabled automatically whenever the terminal disconnects from the packet data service or ends a packet data communication with the best-effort network 102.

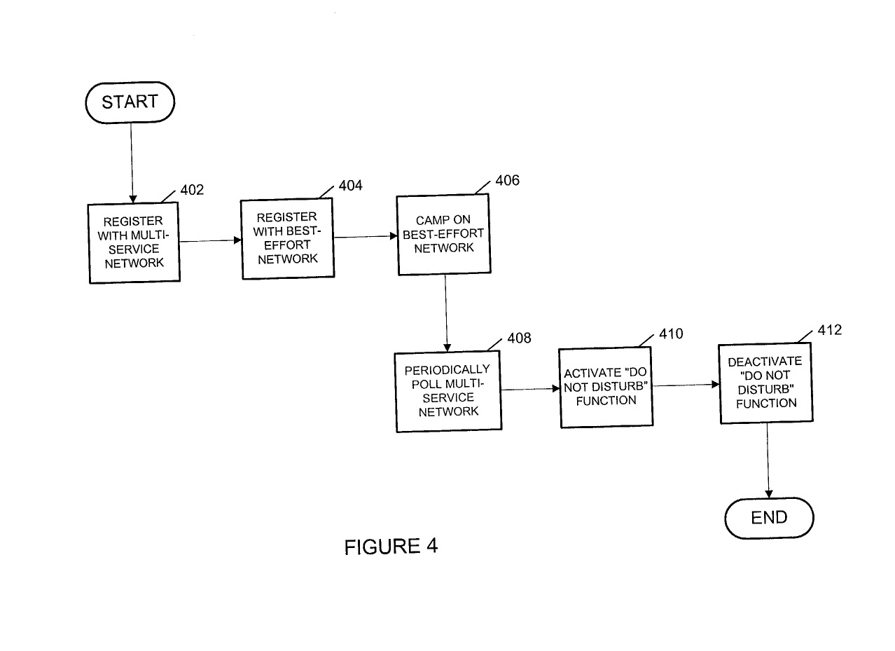

FIG. 4 is a flow chart illustrating one example method by which a terminal can reduce the messaging overhead in a wireless communication network, such as network 101, and avoid unwanted incoming communications. First, in step 402, the terminal registers with a multi-service network 101, e.g., with MSC 140, and then, in step 404, the terminal registers with a best-effort network, e.g., packet data switching network 155. In step 406, the terminal camps on a HDR carrier of the best-effort network, but in step 408, the terminal periodically polls the multi-service network for pages notifying the terminal of an incoming voice or data communication over such multi-service network.

In step 410, the terminal user activates a do not disturb function. As mentioned above, this activation can, for example, be accomplished via a key or through a voice command. The activation causes the terminal to tune to a carrier in the multi-service service network and to de-register with such multi-service network. Thus, if there are incoming voice or data communications intended for the terminal, the multi-service network will not page the terminal because the terminal is not registered in the network.

In step 412, the user disables the do not disturb function, causing the terminal to tune to the carrier of the multi-service network and re-register with such network. Now, if there is an incoming voice or data communication directed to the terminal, the multi-service network will page the terminal and the user can receive the communication.

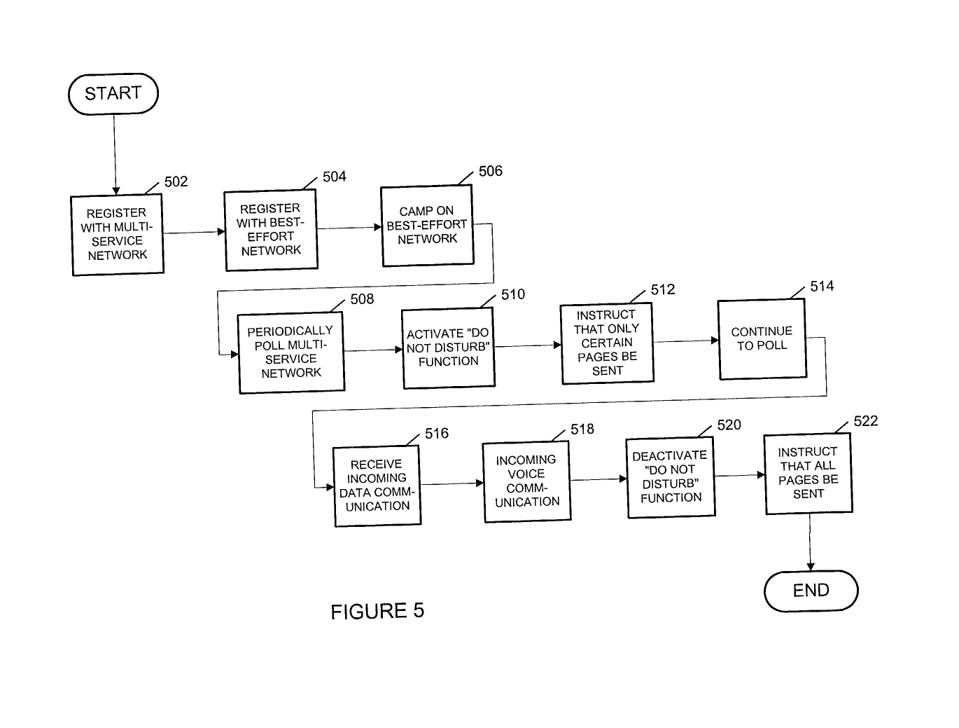

An alternative method is illustrated by the flow chart of FIG. 5. Steps 502, 504, 506, 508, and 510 parallel steps 402, 404, 406, 408, and 410 in FIG. 4. But in the method illustrated by FIG. 5, invoking the do not disturb function, step 510, causes the terminal to tune to the multi-service carrier and instruct the multi-service network to send only certain pages such as those related to incoming data communications, step 512, instead of instructing the multi-service network to stop sending all pages to the terminal. Alternatively, in step 512, the terminal can also instruct the multi-service network to send only certain pages such as those related to incoming voice communications especially when the user is waiting for an important voice call while the terminal is engaged in a packet data communication with the best-effort network.

In step 514, the terminal continues to poll for data pages from the multi-service network after the request has been sent in step 512. Thus, if there is an incoming multi-service data communication, for example, then the terminal can tune to the multi-service carrier and receive it in step 516. The terminal can be configured, however, to obtain user input before receiving the communication. This way, the user still has the choice of not receiving the communication. Alternatively, the terminal can also be configured to automatically display the data communication for viewing by the user especially when such communication is a SMS message or an email.

If a voice communication, for example, intended for the terminal is received, step 518, by the multi-service network after the request is sent in step 512, then no pages will be sent to the terminal based on the request. If the user's subscription to the multi-service network includes a voice mail service, the request sent in step 512 can instruct the multi-service network to forward voice communications to voice mail if such service is available. Otherwise, the multi-service can be configured to notify the caller that the terminal is temporarily unavailable, such as announcing a prerecorded “terminal not responding” message or providing a busy signal.

In step 520, the user disables the do not disturb function, causing the terminal to tune to a carrier in the multi-service network, in step 522, and request that pages for all incoming multi-service communications again be forwarded to the terminal.

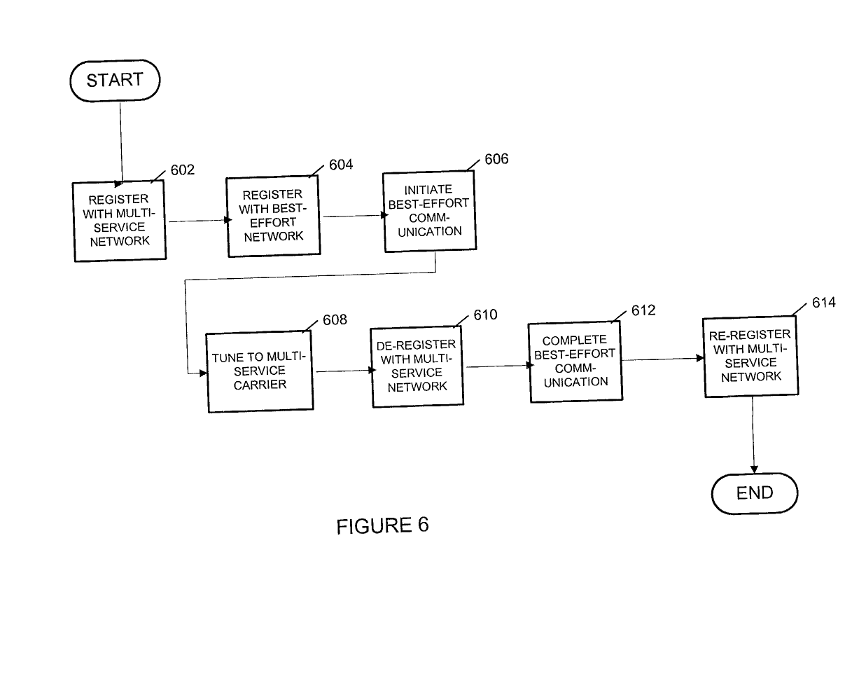

Another alternative method is illustrated by the flow chart of FIG. 6. In step 602, the terminal registers with the multi-service network and then in step 604 it registers with the best-effort network.

In step 606, the terminal tunes to a carrier in the best-effort network and initiates a packet data communication. This causes the terminal to automatically tune to a carrier in the multi-service network in step 608 and to send a de-registration message in step 610. Thus, there will be no pages sent from the multi-service network to the terminal while the packet data communication is occurring.

Once the packet data communication is completed, step 612, the terminal automatically tunes to a multi-service carrier in step 614 and registers with the multi-service network so that pages will once again be sent.

In the above-described embodiments of the present invention, it should be noted that the do not disturb function may be activated or deactivated at any time. In other works, such feature may be activated or deactivated prior to or during a communication between the terminal and one of the networks.

While embodiments and implementations of the invention have been shown and described, it should be apparent that many more embodiments and implementations are within the scope of the invention. Accordingly, the invention is not to be restricted, except in light of the claims and their equivalents.

What is claimed is:

1. A method of wireless communication employing a terminal configured for tuning to either a carrier of a best-effort network or a carrier of a multi-service network, the method comprising:
registering the terminal with the multi-service network;
registering the terminal with the best-effort network;
tuning the terminal to the best-effort carrier;
activating a do not disturb function associated with the terminal; and
de-registering the terminal from the multi-service network in response to the activation of the do not disturb function.

2. The method of claim 1, further comprising:
before de-registering the terminal, tuning the terminal to the multi-service carrier; and
after de-registering the terminal, tuning the terminal to the best-effort carrier.

3. The method of claim 1, further comprising:
disabling the do not disturb function;
tuning the terminal to the multi-service carrier in response to the disabling of the do not disturb function; and
re-registering the terminal with the multi-service network.

4. The method of claim 3, further comprising:
while the terminal is tuned to the best-efforts carrier and is registered with the multi-service network, periodically tuning the terminal to the multi-service carrier to check for incoming communications from the multi-service network.

5. The method of claim 1, wherein activating the do not disturb function occurs automatically upon tuning the terminal to the best-effort carrier.

6. The method of claim 1, further comprising;
after de-registering the terminal, initiating a data communication over the best-effort network.

7. The method of claim 6, wherein the data communication is a packet data communication.

8. The method of claim 7, wherein the packet data communication includes a voice over IP communication.

9. The method of claim 6, wherein activating the do not disturb function occurs automatically upon initiating the data communication.

10. A method of wireless communication employing a terminal configured for tuning to either a carrier of a best-effort network or a carrier of a multi-service network, the method comprising:
registering the terminal with the multi-service network;
registering the terminal with the best-effort network;
tuning the terminal to the best-effort carrier;
activating a do not disturb function associated with the terminal; and
in response to the activation of the do not disturb function, instructing the multi-service network to page the terminal regarding selected incoming communications.

11. The method of claim 10 further comprising:
before activating the do not disturb function, periodically tuning the terminal to the multi-service carrier to check for incoming voice and data communications from the multi-service network.

12. The method of claim 10 further comprising:
after instructing the multi-service network, periodically tuning the terminal to the multi-service carrier to check for the selected incoming communications from the multi-service network.

13. The method of claim 12, further comprising:
receiving the selected incoming data communications from the multi-service carrier.

14. The method of claim 10, wherein the selected incoming communications are incoming voice communications.

15. The method of claim 10, wherein the selected incoming communications are incoming data communications.

16. The method of claim 10, wherein the selected incoming communications are SMS messages.

17. The method of claim 10 further comprising:
before instructing the multi-service network, tuning the terminal to the multi-service carrier; and
after instructing the multi-service network, tuning the terminal back to the best-efforts carrier.

18. The method of claim 10, further comprising:
disabling the do not disturb function;
tuning the terminal to the multi-service carrier in response to the disabling of the do not disturb function; and
instructing the multi-service network to page the terminal regarding all incoming communications.

19. The method of claim 10, wherein activating the do not disturb function occurs automatically upon tuning the terminal to the best-effort carrier.

20. The method of claim 10, further comprising initiating a data communication over the best-effort carrier, and wherein activating the do not disturb function occurs automatically upon initiating the data communication.

21. The method of claim 20, wherein the data communication is a packet data communications.

22. The method of claim 21, wherein the packet data communication includes a voice over IP communication.

23. The method of claim 10, further comprising instructing the multi-service network to forward unselected incoming communications to a voice mail account, while the do not disturb function is activated.

24. The method of claim 10, further comprising instructing the multi-service network to return a “terminal not responding” message when an unselected incoming communication intended for the terminal is received by the multi-service network and the do not disturb function is activated.

25. A terminal for wireless communication, comprising:
a do not disturb function configured to be activated and de-activated;
a transceiver configured to selectively tune to a carrier of a multi-service network or to a carrier of a best-effort network; and
a processor configured to:
tune the transceiver to the multi-service network,
register with the multi-service network,
tune the transceiver to the best-effort carrier,
register with the best-effort network, and
de-registers with the multi-service network when the do not disturb function is activated.

26. The terminal of claim 25, wherein the processor periodically tunes the transceiver to the multi-service carrier from the best-effort carrier to check for incoming voice and data communications.

27. The terminal of claim 25, wherein the processor tunes the transceiver to the multi-service carrier and re-registers the terminal with the multi-service network when the do not disturb function is de-activated.

28. The terminal of claim 25, wherein the processor is configured to activate the do not disturb function in response to a user input.

29. The terminal of claim 28, wherein the user input can be made from a soft key, a dedicated key, or a voice command.

30. The terminal of claim 25, wherein the processor is further configured to initiate a data communication over the best-effort network.

31. The terminal of claim 30, wherein the data communication is a packet data communication.

32. The terminal of claim 31, wherein the packet data communication includes a voice over IP communication.

33. The terminal of claim 30, wherein the processor is configured to automatically activate the do not disturb function before the processor initiates a data communication over the best-effort carrier.

34. The terminal of claim 30, wherein the processor is configured to automatically activate the do not disturb function after the terminal is registered with the best-effort network.

35. A wireless communication network, comprising:
a multi-service network comprising a multi-service carrier;
a best-effort network comprising a best-effort carrier; and
a terminal comprising:
a do not disturb function configured to be activated and de-activated;
a transceiver configured to selectively tune to the multi-service carrier or to the best-efforts carrier; and
a processor configured to:
tune the transceiver to the multi-service carrier,
register the terminal with the multi-service network,
tune the transceiver to the best-effort carrier,
register the terminal with the best-effort network, and
de-register the terminal from the multi-service network or instruct the multi-service network to page the terminal regarding selected incoming communications when the do not disturb function is activated.

36. The wireless communication network of claim 35, wherein the selected incoming communications are incoming voice communications.

37. The wireless communication network of claim 35, wherein the selected incoming communications are incoming data communications.

38. The wireless communication network of claim 35, wherein the selected incoming communications are SMS messages.

39. The wireless communication network of claim 35, wherein the processor is further configured to initiate a data communication over the best-effort network.

40. The wireless communication network of claim 39, wherein the data communication is a packet data communication.

41. The wireless communication network of claim 40, wherein the packet data communication includes a voice over IP communication.

42. The wireless communication network of claim 41, wherein the terminal is further configured to automatically activate the do not disturb function whenever the processor initiates a data communication over the best-effort carrier.

43. The wireless communication network of claim 35, wherein the terminal is further configured to automatically activate the do not disturb function upon registration with the best-effort network.

44. The wireless communication network of claim 35, wherein the terminal is configured to activate the do not disturb mode in response to a user input.

45. The wireless communication network of claim 44, wherein the user input can be made from a soft key, a dedicated key, or a voice command.

46. The wireless communication network of claim 35, wherein the processor is further configured to instruct the multi-service network to forward unselected incoming communications to a voice mail account, while the do not disturb function is activated.

47. The wireless communication network of claim 35, wherein the processor is further configured to instruct the multi-service network to return a “terminal not responding” message when an unselected incoming communication intended for the terminal is received by the multi-service network and the do not disturb function is activated.

48. A terminal for wireless communication, comprising:
a do not disturb function configured to be activated and de-activated;
a transceiver configured to selectively tune to a carrier of a multi-service network or to a carrier of a best-effort network; and
a processor configured to:
tune the transceiver to the multi-service network,
register with the multi-service network,
tune the transceiver to the best-effort carrier,
register the terminal with the best-effort network, and
instruct the multi-service network to page the terminal regarding selected incoming communications when the do not disturb function is activated.

49. The terminal of claim 48, wherein the processor is further configured to instruct the multi-service network that incoming voice communications be sent to a voice mail service when the do not disturb function is activated.

50. The terminal of claim 48, wherein the processor is further configured to instruct the multi-service network to return a “terminal not responding” message when an incoming voice communication intended for the terminal is received by the multi-service network and the do not disturb function is activated.

51. The terminal of claim 48, wherein the processor is further configured to tune the transceiver to the multi-service carrier and instruct the multi-service network that notifications of all incoming communications be sent to the terminal when the do not disturb mode is de-activated.

52. The terminal of claim 48, wherein the processor is further configured to periodically tune the transceiver to the multi-service carrier to check for incoming data communications, while the do not disturb mode is activated.

53. The terminal of claim 52, wherein the processor is further configured to retrieve an incoming data communication in the event there is one and then tune back to the best-effort carrier after retrieving the data communication.

54. The terminal of claim 48, wherein the selected incoming communications are incoming voice communications.

55. The terminal of claim 48, wherein the selected incoming communications are incoming data communications.

56. The terminal of claim 48, wherein the selected incoming communications are SMS messages.

57. The terminal of claim 48, wherein the processor is further configured to initiate a data communication over the best-effort network.

58. The terminal of claim 57, wherein the data communication is a packet data communication.

59. The terminal of claim 58, wherein the packet data communication includes a voice over IP communication.

60. The terminal of claim 57, wherein the processor is configured to automatically activate the do not disturb function before the processor initiates a data communication over the best-effort carrier.

61. The terminal of claim 48, wherein the processor is configured to automatically activate the do not disturb function after the terminal is registered with the best-effort network.

62. The terminal of claim 48, wherein the processor is configured to activate the do not disturb mode in response to a user input.

63. The wireless communication network of claim 62, wherein the user input can be made from a soft key, a dedicated key, or a voice command.
